(19) United States
(12) Patent Application Publication
(10) Pub. No.: US 2014/0352486 A1
(43) Pub. Date: Dec. 4, 2014

(54) POSITIONING ASSEMBLIES

(71) Applicant: Hewlett-Packard Development Company, L.P., Houston, TX (US)

(72) Inventors: Eduardo Ruiz Martinez, Sant Cugat del Valles (ES); Joaquim Brugue Garvi, Barcelona (ES); Daniel Gonzalez Perello, Terrassa (ES)

(21) Appl. No.: 13/905,941

(22) Filed: May 30, 2013

(51) Int. Cl. G05G 5/16

(52) U.S. Cl. CPC G05G 5/16
USPC 74/531

(57) ABSTRACT

A positioning assembly is disclosed herein. An example includes a guide shaft having a longitudinal axis and a housing movable along and rotatable about the longitudinal axis of the guide shaft. The housing is also transversely movable and transversely rotatable with respect to the longitudinal axis of the guide shaft. The example of the positioning assembly additionally has a brake mechanism including at least one shoe and a caliper eccentrically mounted on the guide shaft and moveable from a first position that permits movement and rotation of the housing to a second position that impedes movement and rotation of the housing. Other elements and features of the positioning assembly are disclosed herein, as are other examples of positioning assemblies.

### BACKGROUND

Devices may need to be positioned within a certain degree of accuracy. Such devices may, alternatively or additionally, need to be maintained in an arranged position and/or subsequently repositioned within the same degree of accuracy. Designers and manufacturers may, therefore, endeavor to create and supply products that accomplish one or more of these objectives for such devices.

### BRIEF DESCRIPTION OF THE DRAWINGS

The following detailed description references the drawings, wherein:

FIG. 1 is an example of a perspective view of a positioning assembly.

FIG. 2 is an example of an exploded perspective view of the positioning assembly of FIG. 1.

FIG. 3 is an example of movement of a housing of the positioning assembly of FIG. 1 along a longitudinal axis.

FIG. 4 is an example of rotation of the housing of the positioning assembly of FIG. 1 about the longitudinal axis.

FIG. 5 is an example of rotation of the housing of the positioning assembly of FIG. 1 about a first axis that is transverse to the longitudinal axis.

FIG. 6 is an example of movement of the housing of the positioning assembly of FIG. 1 along the first axis.

FIG. 7 is an example of movement of the housing of the positioning assembly of FIG. 1 along a second axis that is transverse to the longitudinal axis.

FIG. 8 is an additional example of movement of the housing of the positioning assembly of FIG. 7 in a different direction along the second axis.

FIG. 9A is an example of a cross-sectional view of the positioning assembly taken along line 9-9 of FIG. 1 illustrating a brake mechanism in a first position.

FIG. 9B is another example of a cross-sectional view of the positioning assembly taken along line 9-9 of FIG. 1 illustrating the brake mechanism in a second position.

FIG. 10A is an example of a cross-sectional view of the positioning assembly taken along line 10-10 of FIG. 1 illustrating the brake mechanism in the first position.

FIG. 10B is another example of a cross-sectional view of the positioning assembly taken along line 10-10 of FIG. 1 illustrating the brake mechanism in the second position.

FIG. 11 is an example of a perspective view of a device coupled to the housing of the positioning assembly of FIG. 1.

FIG. 12 is another example of a perspective view of a positioning assembly.

FIG. 13 is an example of an exploded perspective view of the positioning assembly of FIG. 12.

FIG. 14A is an example of a cross-sectional view of the positioning assembly taken along line 14-14 of FIG. 12 illustrating a brake mechanism in a first position.

FIG. 14B is another example of a cross-sectional view of the positioning assembly taken along line 14-14 of FIG. 12 illustrating the brake mechanism in a second position.

FIG. 15A is an example of a cross-sectional view of the positioning assembly taken along line 15-15 of FIG. 12 illustrating the brake mechanism in the first position.

FIG. 15B is another example of a cross-sectional view of the positioning assembly taken along line 15-15 of FIG. 12 illustrating the brake mechanism in the second position.

FIG. 16 is an example of rotation of a housing of an alternative positioning assembly about a first axis that is transverse to the longitudinal axis.

FIG. 17 is an example of movement of the housing of the positioning assembly of FIG. 16 along the first axis.

### DETAILED DESCRIPTION

Accurate positioning of devices is desirable in many applications, such as pen-to-paper spacing in inkjet printing, as well as service station alignment for such inkjet pens. Other non-limiting application examples requiring accurate positioning include manufacturing, surgery, photography, acoustics, test and measurement, and certain military uses. The ability to adjust such positioning to bring things back into tolerance ranges is also helpful to compensate for incorrect positioning resulting from, for example, extended and/or rough use, as well as wear and tear of various components over time.

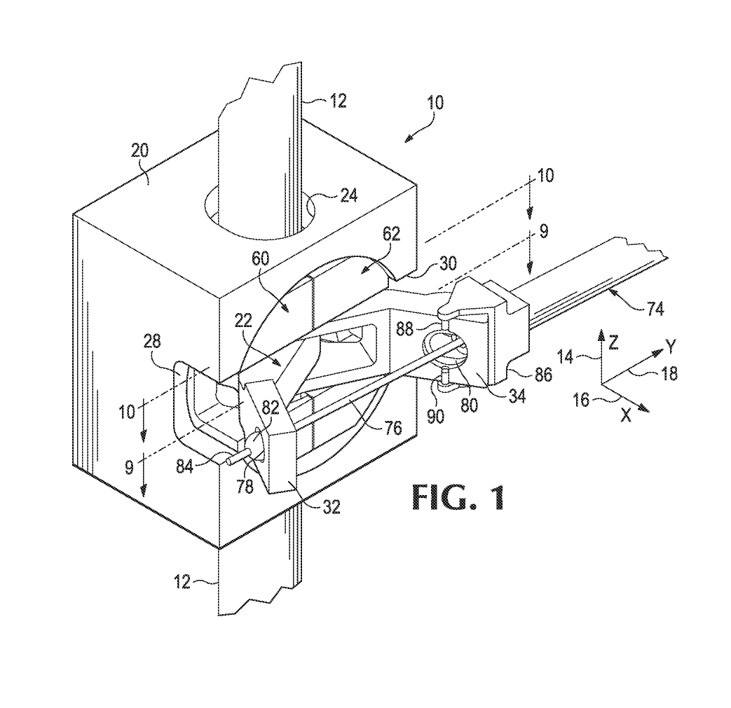

An example of a positioning assembly 10 that is directed to addressing these challenges is illustrated in FIG. 1. As can be seen in FIG. 1, positioning assembly 10 includes a guide shaft 12 having a longitudinal axis 14, a first axis 16, and a second axis 18. In this example, longitudinal axis 14 represents a z-axis, first axis 16 represents an x-axis that is substantially perpendicular to longitudinal axis 14, and second axis 18 represents a y-axis (substantially perpendicular to first axis 16) of a three-dimensional coordinate system. It is to be understood, however, that in other examples, longitudinal axis 14, first axis 16 and/or second axis 18 may represent one or more other axes of the same or a different type of coordinate system.

As can also be seen in FIG. 1, positioning assembly 10 also includes a housing 20 disposed on guide shaft 12 and a brake mechanism 22 disposed on guide shaft 12. As discussed more fully below, brake mechanism 22 is moveable between a first position that permits movement of housing 20 along and about longitudinal axis 12, along and about first axis 16, and along second axis 18, and a second position that impedes movement of housing 20 along and about longitudinal axis 12, along and about first axis 16, and along second axis 18.

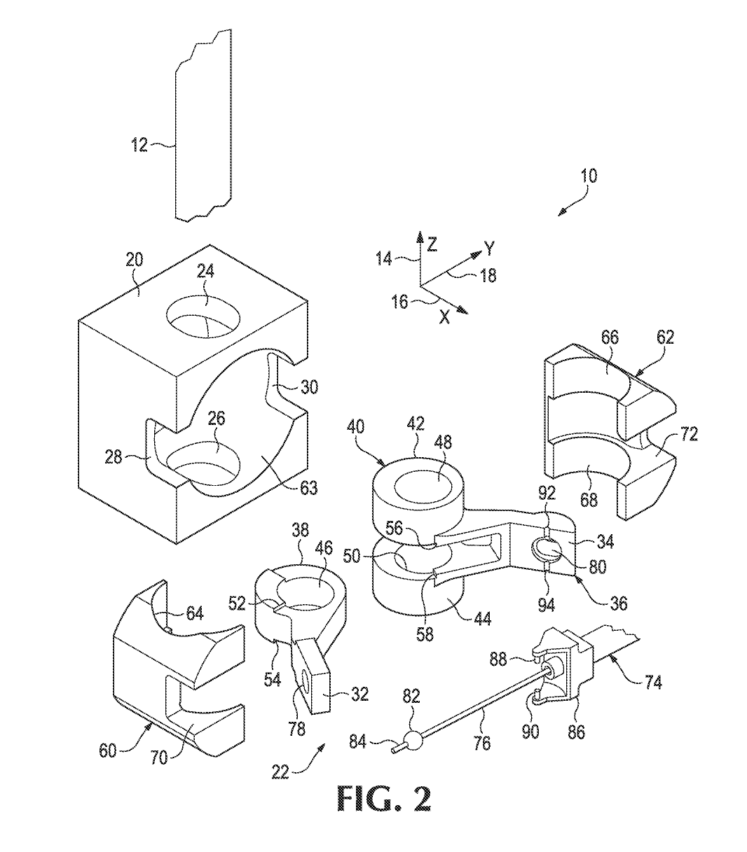

An example of an exploded perspective view of positioning assembly 10 is shown in FIG. 2. As can be seen in FIG. 2, housing 20 of positioning assembly 10 defines a first opening 24 and a second opening 26 through which guide shaft 12 is disposed. In this example, both respective first and second openings 24 and 26 have a generally oval or elliptical shape that helps to facilitate the above-described movements of housing 20 along and about longitudinal axis 14, along and about first axis 16, and along second axis 18. Although first and second openings 24 and 26 of housing 20 have a generally oval or elliptical shape, it is to be understood that either or both of first and second openings 24 and 26 may have a different shape in other examples of positioning assembly 10. Housing 20 additionally includes cut-outs 28 and 30 that receive and provide clearance for first arm 32 and second arm 34 of caliper 36 of brake mechanism 22, as described more fully below.

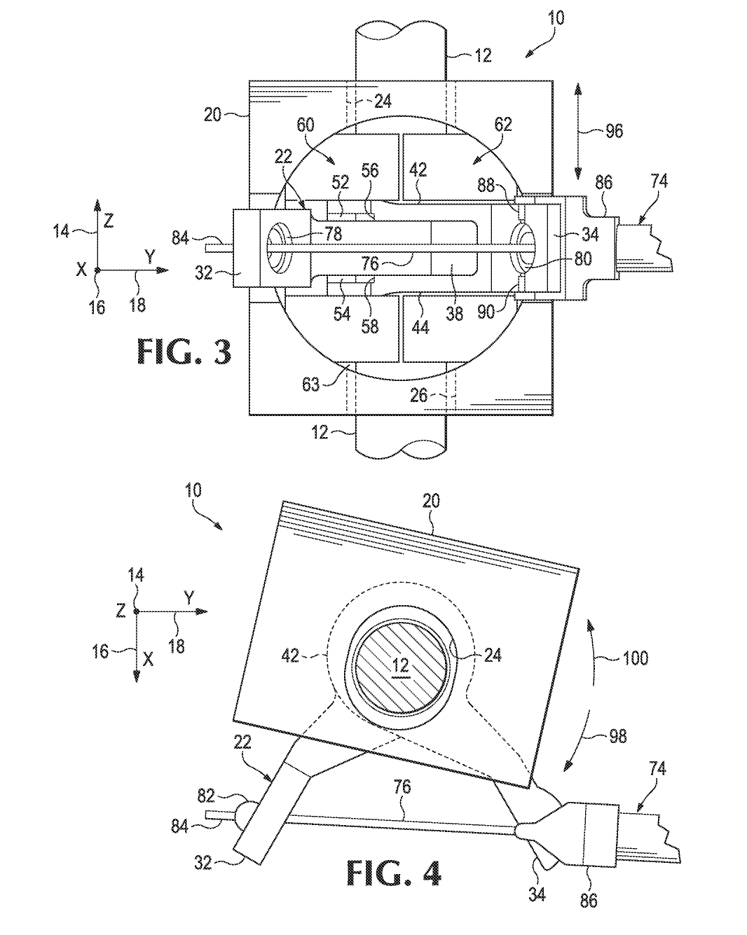

As can also be seen in FIG. 2, first arm 32 includes a first lobe 38 and second arm 34 includes a second lobe 40 having a first portion 42 and a second portion 44. First lobe 38 of first arm 32 defines an opening 46 that allows first arm 32 to be mounted on guide shaft 12 and respective first and second portions 42 and 44 of second lobe 40 of second arm 34 define openings 48 and 50 that allow second arm 34 to be mounted on guide shaft 12. First and second portions 42 and 44 of second arm 34 are spaced apart relative to one another so as to receive first lobe 38, as shown, for example, in FIG. 3.

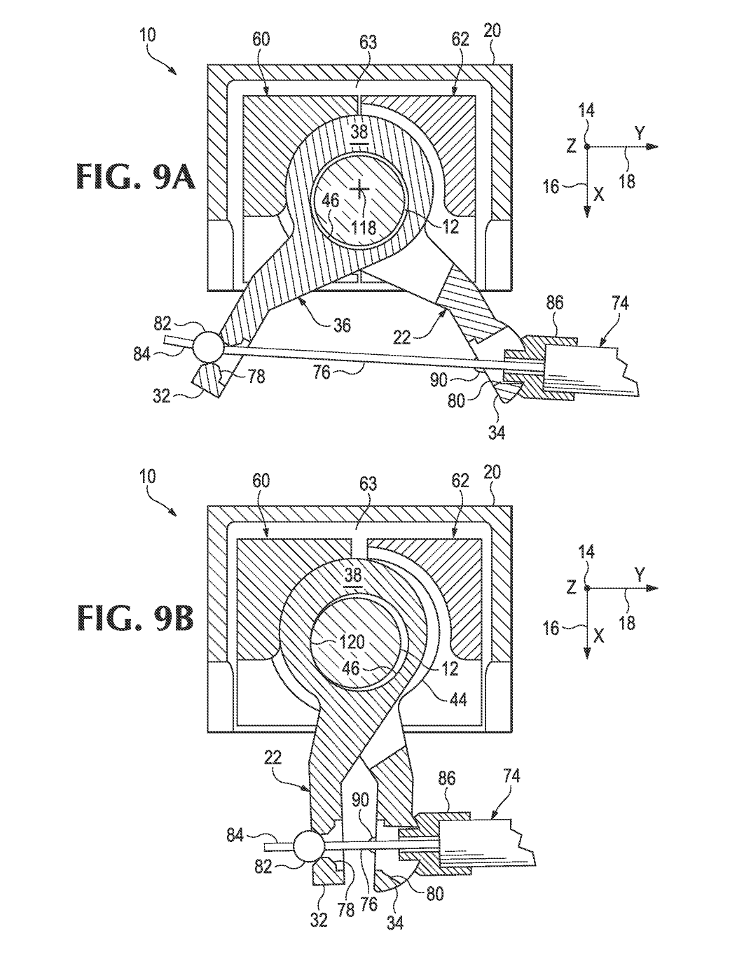

Referring again to FIG. 2, first arm 32 additionally includes a first raised portion 52 and a second raised portion 54 that contact respective portions 56 and 58 of second arm 34 as brake mechanism 22 is moved from the first position shown, for example, in FIG. 9A to the second position shown, for example, in FIG. 9B. This contact between first and second raised portions 52 and 54 and respective portions 56 and 58 helps to limit or stop movement of brake mechanism 22 from the first position to the second position.

As can additionally be seen in FIG. 2, brake mechanism 22 includes a first pad or shoe 60 and a second pad or shoe 62 that are disposable in interior or cavity 63 of housing 20. First pad or shoe 60 includes a recess 64 that receives first lobe 38 of first arm 32 and second pad or shoe 62 includes a recess 66 that receives first portion 42 of second lobe 40 of second arm 34 and a recess 68 that receives second portion 44 of second lobe 40 of second arm 34. First pad or shoe 60 additionally includes a cut-out 70 that receives and provides clearance for first arm 32 of caliper 36 of brake mechanism 22, and second pad or shoe 62 additionally includes a cut-out 72 that receives and provides clearance for second arm 34 of caliper 36 of brake mechanism 22.

As can further be seen in FIG. 2, positioning assembly 10 additionally includes an actuator 74 to move brake mechanism 22 between the first position shown, for example, in FIG. 9A and the second position shown, for example, in FIG. 9B. In this example, actuator 74 includes a cable assembly 76 that is disposed through openings 78 and 80 of respective first and second arms 32 and 34, as shown, for example, in FIG. 1. A sphere or ball 82 adjacent end 84 of cable assembly 76 has a larger diameter or radius than a diameter or radius of opening 78 in first arm 32 so that sphere or ball 82 does not pass through opening 78 when cable assembly 76 is actuated. Cable assembly 76 of actuator 74 also includes a clip 86 that fits on and attaches to second arm 34 via tabs 88 and 90 that are disposed in respective slots 92 and 94 in second arm 34.

Although in this example of positioning assembly 10, actuator 74 is illustrated as including a cable assembly 76, it is to be understood that actuator 74 may include different structures or mechanisms. For example, actuator 74 may include a motor with a shaft or gear assembly (such as an electric motor with a worm gear), a hydraulic cylinder, a pneumatic cylinder, etc.

An example of movement of housing 20 of positioning assembly 10 along longitudinal axis 14 is shown in FIG. 3. As can be seen in FIG. 3, brake mechanism 22 is in the first position that permits movement of housing 20 along longitudinal axis 14 in either of the directions of double-headed arrow 96 which is substantially parallel to longitudinal axis 14.

An example of rotation of housing 20 of positioning assembly 10 about longitudinal axis 14 is shown in FIG. 4. As can be seen in FIG. 4, brake mechanism 22 is in the first position that permits movement of housing 20 about longitudinal axis 14 in the direction of arrow 98, as shown. Although not shown in FIG. 4, it is to be understood that first position of brake mechanism 22 also permits movement of housing 20 about longitudinal axis 14 in the direction of arrow 100 as well.

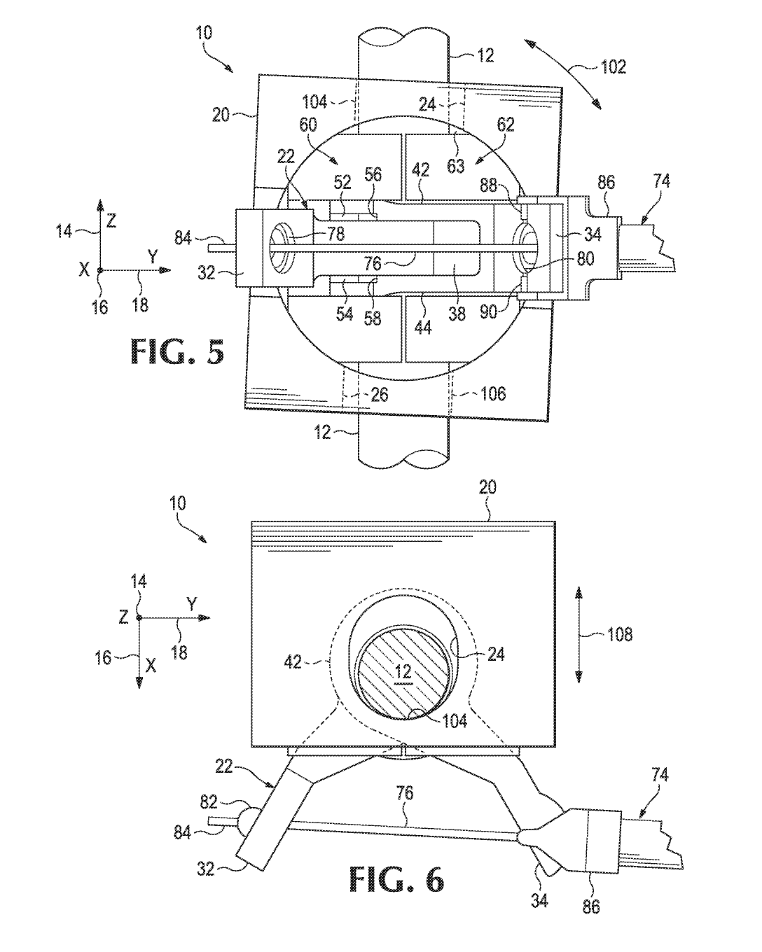

An example of rotation of housing 20 of positioning assembly 10 about first axis 16 that is transverse to longitudinal axis 14 is shown in FIG. 5. As can be seen in FIG. 5, brake mechanism 22 is in the first position that permits rotation of housing about first axis 16 in either of the directions indicated by double-headed arrow 102. As can be seen in FIG. 5, the extent of this rotation is limited by contact between side 104 of first opening 24 and guide shaft 12 and side 106 of second opening 26 and guide shaft 12.

An example of movement of housing 20 of positioning assembly 10 along first axis 16 that is transverse to longitudinal axis 14 is shown in FIG. 6. As can be seen in FIG. 6, brake mechanism 22 is in the first position that permits movement of housing 20 along first axis 16 in either of the directions of double-headed arrow 108 which is substantially parallel to first axis 16. As can also be seen in FIG. 6, the extent of this movement is limited by contact between side 104 of first opening 24 and guide shaft 12. Contact between side 106 of second opening 26 (not shown in FIG. 6) and guide shaft 12 also limits the extent of this movement.

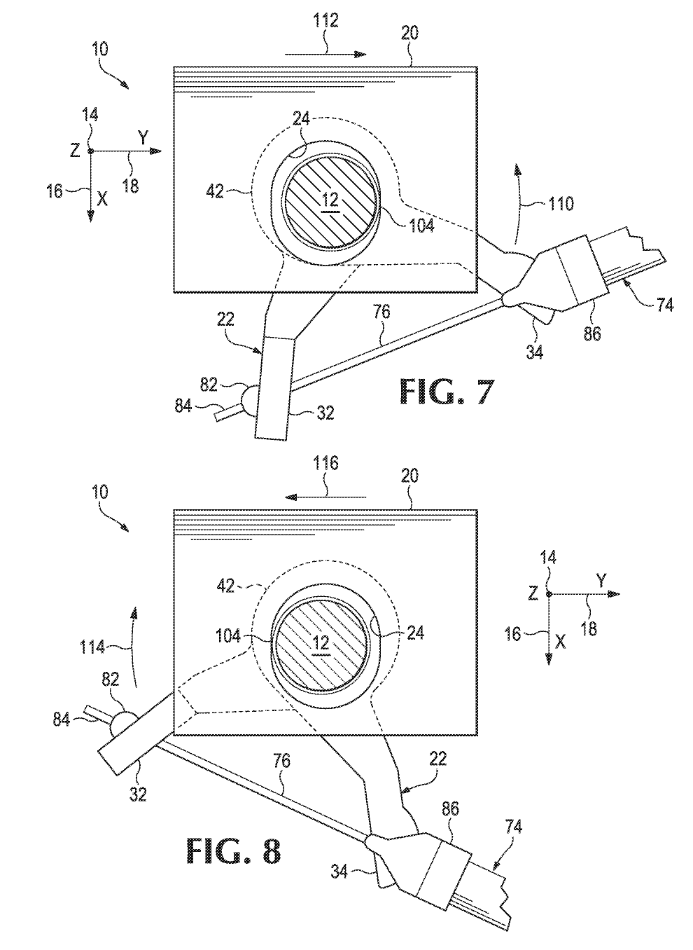

An example of movement of housing 20 of the positioning assembly 10 along second axis 18 that is transverse to longitudinal axis 14 is shown in FIG. 7. As can be seen in FIG. 7, brake mechanism 22 is in the first position and has been rotated about guide shaft 12 in the direction of arrow 110 which permits or results in movement of housing 20 along second axis 18 in the direction of arrow 112 which is substantially parallel to second axis 18. As can also be seen in FIG. 7, the extent of this movement is limited by contact between side 104 of first opening 24 and guide shaft 12. Contact between side 106 of second opening 26 (not shown in FIG. 7) and guide shaft 12 also limits the extent of this movement.

An additional example of movement of housing 20 of the positioning assembly 10 in a different direction along second axis 18 that is transverse to longitudinal axis 14 is shown in FIG. 8. As can be seen in FIG. 8, brake mechanism 22 is in the first position and has be rotated about guide shaft 12 in the direction of arrow 114 which is generally opposite to the direction of arrow 110. This rotation permits or results in movement of housing 20 along second axis 18 in the direction of arrow 116 which is substantially parallel to second axis 18 and generally opposite to the direction of arrow 112. As can also be seen in FIG. 8, the extent of this movement is limited by contact between side 104 of first opening 24 and guide shaft 12. Contact between side 106 of second opening 26 (not shown in FIG. 7) and guide shaft 12 also limits the extent of this movement.

An example of a cross-sectional view of positioning assembly 10 taken along line 9-9 of FIG. 1 illustrating brake mechanism 22 in the first position is shown in FIG. 9A. Another example of a cross-sectional view of positioning assembly 10 taken along line 9-9 of FIG. 1 illustrating brake mechanism 22 in the second position is shown in FIG. 9B. As can be seen by comparison of FIGS. 9A and 9B, respective first and second arms 32 and 34 are in closer proximity to one another in the second position illustrated in FIG. 9B than in the first position illustrated in FIG. 9A. This movement of brake mechanism 22 from the first position illustrated in FIG. 9A to the second position illustrated in FIG. 9B results from the shortening of cable assembly 76 which pulls respective first and second arms 32 and 34 together.

As can be seen, for example in FIG. 9A, opening 46 is not located at geometric center 118 of first lobe 38 so that first arm 32 of caliper 36 is eccentrically mounted on guide shaft 12. As can be seen in FIG. 9B, when brake mechanism 22 is in the second position, this eccentric mounting of first arm 32 of caliper 36 on guide shaft 12 helps impede movement of housing 20 along and about longitudinal axis 14 of guide shaft 12 by virtue of contact between side 120 of first lobe 38 and guide shaft 12.

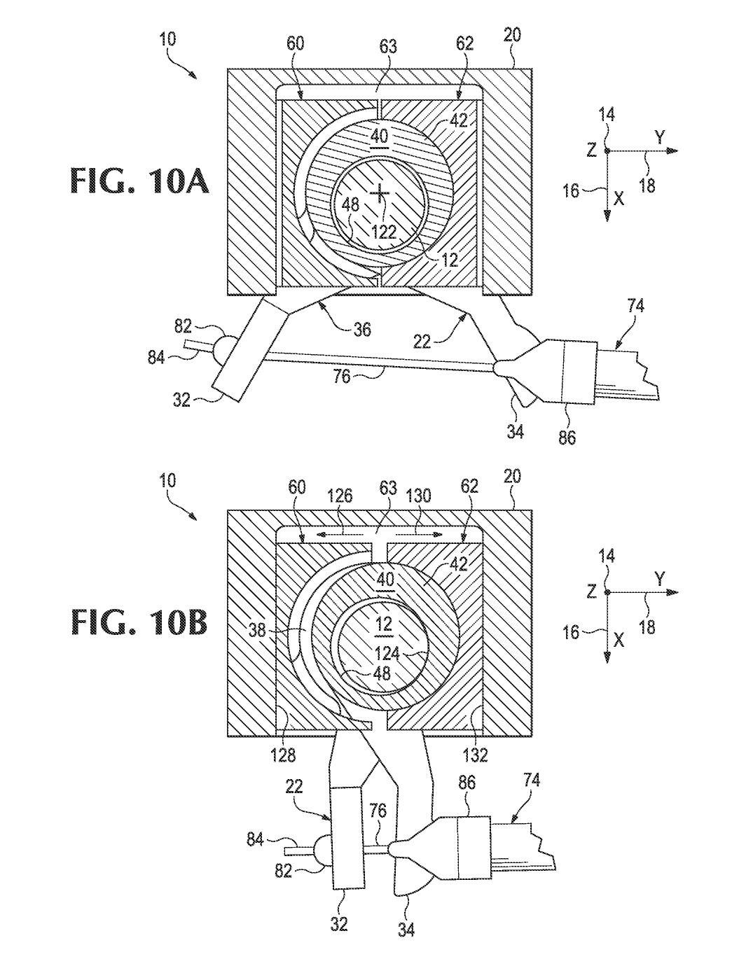

An example of a cross-sectional view of positioning assembly 10 taken along line 10-10 of FIG. 1 illustrating brake mechanism 22 in the first position is shown in FIG. 10A. Another example of a cross-sectional view of positioning assembly 10 taken along line 10-10 of FIG. 1 illustrating brake mechanism 22 in the second position is shown in FIG. 10B. As can be seen, for example in FIG. 10A, opening 48 is not located at geometric center 122 of first portion 42 of second lobe 40 so that second arm 34 of caliper 36 is eccentrically mounted on guide shaft 12. As can be seen in FIG. 10B, when brake mechanism 22 is in the second position, this eccentric mounting of second arm 34 of caliper 36 on guide shaft 12 helps impede movement of housing 20 along and about longitudinal axis 14 of guide shaft 12 by virtue of contact between side 124 of first portion 42 of second lobe 40 and guide shaft 12. Although not shown in FIG. 10A, it is to be understood that opening 50 is also not located at the geometric center of second portion 44 of second lobe 40.

As can be seen, for example, by comparison of FIGS. 10A and 10B, movement of brake mechanism 22 from the first position to the second position causes first lobe 38 of first arm 32 to actuate first pad or shoe 60 in the direction of arrow 126 against side 128 of housing 20, thereby impeding movement of housing 20 along and about first axis 16, as well as along second axis 18. As can also be seen by comparison of FIGS. 10A and 10B, movement of brake mechanism 22 from the first position to the second position also causes second lobe 40 of second arm 34 to actuate second pad or shoe 62 in the direction of arrow 130 against side 132 of housing 20, thereby also impeding movement of housing 20 along and about first axis 16, as well as along second axis 18.

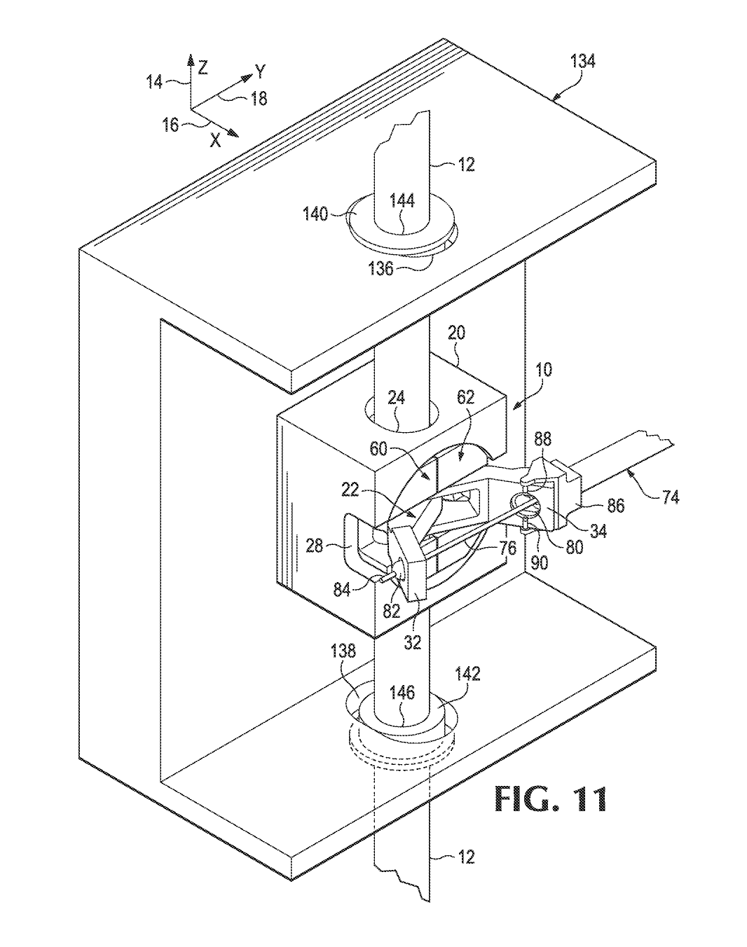

An example of a device 134 (e.g., an inkjet printer carriage assembly) coupled to housing 20 of positioning assembly 10 is shown in FIG. 11. As can be seen in FIG. 11, device 134 defines a first opening 136 and a second opening 138 through which guide shaft 12 is disposed. In this example, both respective first and second openings 136 and 138 have a generally oval or elliptical shape that helps to facilitate tracking of the above-described movements of housing 20 to which device 134 is coupled.

As can also be seen in FIG. 11, device 134 includes a first bushing 140 disposed in first opening 136 and a second bushing 142 disposed in second opening 138. Guide shaft 12 is disposed through openings 144 and 146 defined by respective first and second bushings 140 and 142, as shown. First and second bushings 140 and 142 help device 134 more smoothly track the movements of housing 20 to which device 134 is coupled.

As discussed above and illustrated, for example, in FIGS. 9B and 10B, brake mechanism 22 of positioning assembly 10 is moveable to a second position by actuator 74 that impedes movement of housing 20 along and about longitudinal axis 14, along and about first axis 16, and along second axis 18. Movement of device 134 is also similarly impeded by virtue of the coupling between housing 20 and device 134. However, such movement of device 134 is impeded independent of application of resistive forces on device 134. This helps prevent deformation of device 134, as well as wear and tear on device 134.

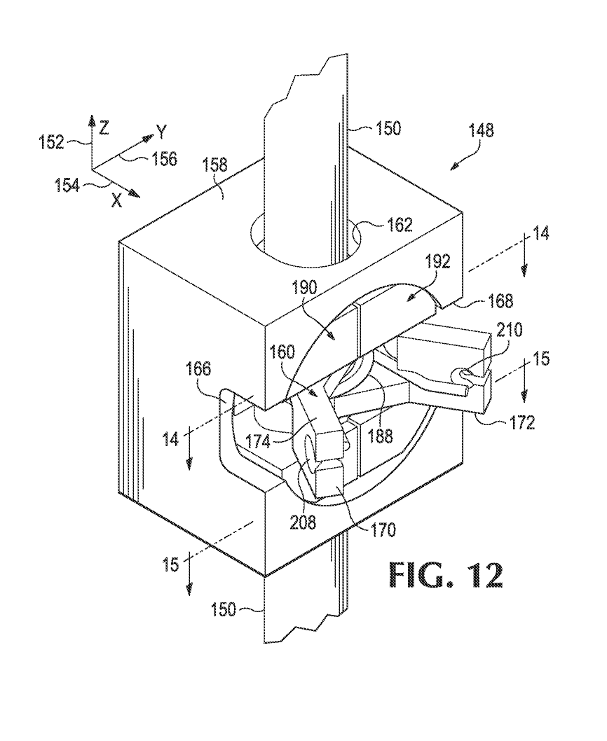

An example of another positioning assembly 148 is illustrated in FIG. 12. As can be seen in FIG. 12, positioning assembly 148 includes a guide shaft 150 having a longitudinal axis 152, a first axis 154 that is transverse to longitudinal axis 152, and a second axis 156 that is also transverse to longitudinal axis 152. In this example, longitudinal axis 152 represents a z-axis, first axis 154 represents an x-axis that is substantially perpendicular to longitudinal axis 152, and second axis 156 represents a y-axis (substantially perpendicular to first axis 154) of a three-dimensional coordinate system. It is to be understood, however, that in other examples, longitudinal axis 152, first axis 154 and/or second axis 156 may represent one or more other axes of the same or a different type of coordinate system.

As can also be seen in FIG. 12, positioning assembly 148 also includes a housing 158 disposed on guide shaft 150 and a brake mechanism 160 disposed on guide shaft 150. As discussed more fully below, brake mechanism 160 is moveable between a first position that permits movement of housing 158 along and about longitudinal axis 152, along and about first axis 154, and along second axis 156, and a second position that impedes movement of housing 158 along and about longitudinal axis 152, along and about first axis 154, and along second axis 156.

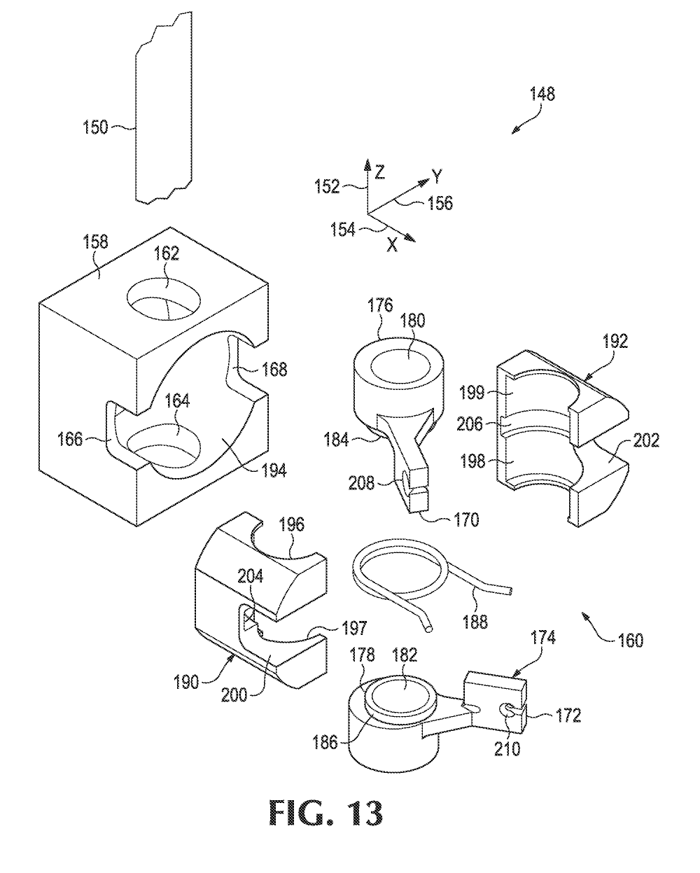

An example of an exploded perspective view of positioning assembly 148 is shown in FIG. 13. As can be seen in FIG. 13, housing 158 of positioning assembly 148 defines a first opening 162 and a second opening 164 through which guide shaft 150 is disposed. In this example, both respective first and second openings 162 and 164 have a generally oval or elliptical shape that helps to facilitate the above-described movements of housing 158 along and about longitudinal axis 152, along and about first axis 154, and along second axis 156. Although first and second openings 162 and 164 of housing 158 have a generally oval or elliptical shape, it is to be understood that either or both of first and second openings 162 and 164 may have a different shape in other examples of positioning assembly 148. Housing 158 additionally includes cut-outs 166 and 168 that receive and provide clearance for first arm 170 and second arm 172 of caliper 174 of brake mechanism 160.

As can also be seen in FIG. 13, first arm 170 includes a first lobe 176 and second arm 172 includes a second lobe 178. First lobe 176 of first arm 170 defines an opening 180 that allows first arm 170 to be mounted on guide shaft 150 and second arm 172 defines opening 182 that allows second arm 172 to be mounted on guide shaft 150. First and second arms 170 and 172 additionally include respective raised portions 184 and 186 on which a biasing member 188 is disposed. Biasing member 188 helps to retain caliper 174 in the first position, as shown, for example, in FIG. 12.

Referring again to FIG. 13, brake mechanism 160 includes a first pad or shoe 190 and a second pad or shoe 192 that are disposable in interior or cavity 194 of housing 158. First pad or shoe 190 includes a recess 196 that receives first lobe 176 of first arm 170 and a recess 197 that receives second lobe 178 of second arm 172. Second pad or shoe 192 includes a recess 198 that receives second lobe 178 of second arm 172 and a recess 199 that receives first lobe 176 of first arm 170. First pad or shoe 190 additionally includes a cut-out 200 that receives and provides clearance for first arm 170 of caliper 174 of brake mechanism 160 and second pad or shoe 192 additionally includes a cut-out 202 that receives and provides clearance for second arm 172 of caliper 174 of brake mechanism 160. First pad or shoe 190 further includes a recess 204 that receives biasing member 188 and second pad or shoe 192 additionally includes a recess 206 that also receives biasing member 188.

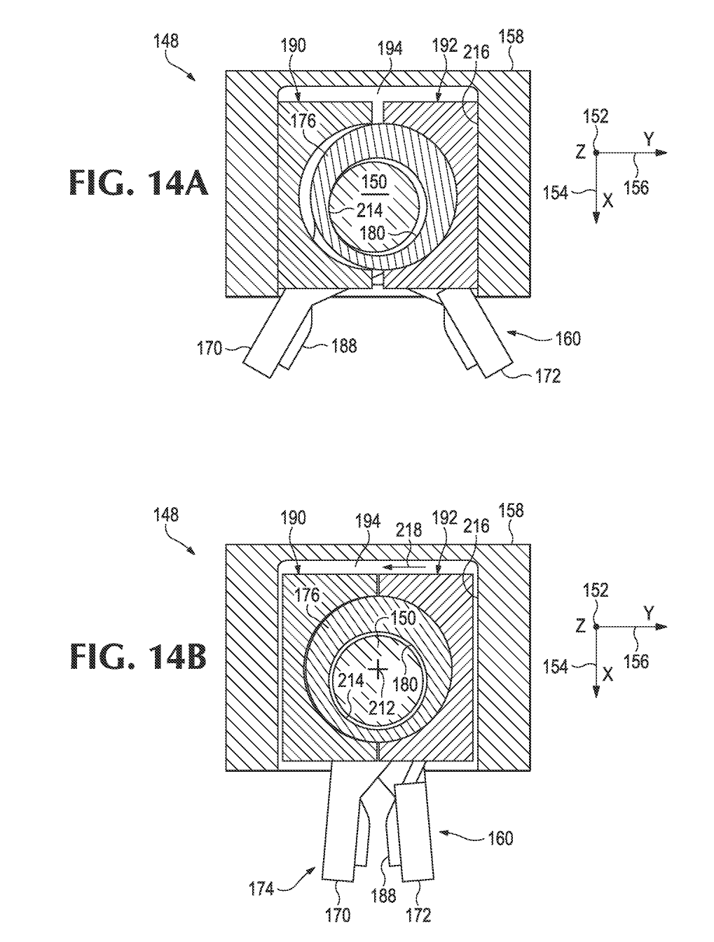

Although not shown in FIG. 13, positioning assembly 148 additionally includes an actuator to move brake mechanism 160 against the urging of biasing member 188 from the first position shown, for example, in FIG. 14A to the second position shown, for example, in FIG. 14B. This actuator may include a cable assembly, like cable assembly 76, which is disposed through openings 208 and 210 of respective first and second arms 170 and 172. This actuator may also include different structures or mechanisms such as a motor with a shaft or gear assembly (such as an electric motor with a worm gear), a hydraulic cylinder, a pneumatic cylinder, etc.

An example of a cross-sectional view of positioning assembly 148 taken along line 14-14 of FIG. 12 illustrating brake mechanism 160 in the first position is shown in FIG. 14A. Another example of a cross-sectional view of positioning assembly 148 taken along line 14-14 of FIG. 12 illustrating brake mechanism 160 in the second position is shown in FIG. 14B. As can be seen by comparison of FIGS. 14A and 14B, respective first and second arms 170 and 172 are in closer proximity to one another in the second position illustrated in FIG. 14B than in the first position illustrated in FIG. 14A. This movement of brake mechanism 160 from the first position illustrated in FIG. 14A to the second position illustrated in FIG. 14B results from use of an actuator (not shown) which opposes the urging of biasing member 188 to move respective first and second arms 170 and 172 together.

As can be seen, for example in FIG. 14B, opening 180 is not located at geometric center 212 of first lobe 176 so that first arm 170 of caliper 174 is eccentrically mounted on guide shaft 150. As can be seen in FIG. 14A, when brake mechanism 160 is in the first position, this eccentric mounting of first arm 170 of caliper 174 on guide shaft 150 helps impede movement of housing 158 along and about longitudinal axis 152 of guide shaft 150 by virtue of contact between side 214 of first lobe 176 and guide shaft 150.

As can be seen in FIG. 14A, in the first position of brake mechanism 160, first lobe 176 of first arm 170 actuates second pad or shoe 192 against side 216 of housing 158, thereby impeding movement of housing 158 along and about first axis 154, as well as along second axis 156. Brake mechanism 160 is retained in this first position shown in FIG. 14A under the urging provided by biasing member 188.

As can be seen, for example, by comparison of FIGS. 14A and 14B, movement of brake mechanism 160 from the first position to the second position causes first lobe 176 of first arm 170 to release second pad or shoe 192 in the direction of arrow 218 from contact against side 216 of housing 158, thereby permitting movement of housing 158 along and about first axis 16, as well as along second axis 18. As can also be seen by comparison of FIGS. 14A and 14B, side 214 of first lobe 176 no longer contacts guide shaft 150 in the second position, thereby permitting movement of housing 158 along and about longitudinal axis 152 of guide shaft 150.

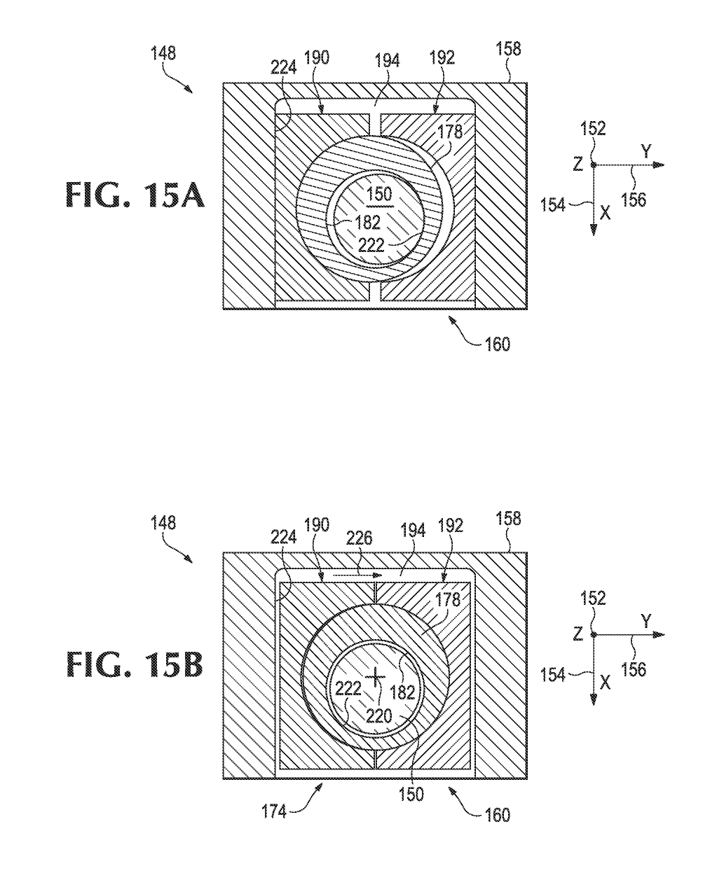

An example of a cross-sectional view of positioning assembly 148 taken along line 15-15 of FIG. 12 illustrating brake mechanism 160 in the first position is shown in FIG. 15A. Another example of a cross-sectional view of positioning assembly 148 taken along line 15-15 of FIG. 12 illustrating brake mechanism 160 in the second position is shown in FIG. 15B. As can be seen, for example, in FIG. 15B, opening 182 is not located at geometric center 220 of second lobe 178 so that second arm 172 of caliper 174 is eccentrically mounted on guide shaft 150. As can be seen in FIG. 15A, when brake mechanism 160 is in the first position, this eccentric mounting of second arm 172 of caliper 174 on guide shaft 150 helps impede movement of housing 158 along and about longitudinal axis 152 of guide shaft 150 by virtue of contact between side 222 of second lobe 178 and guide shaft 150.

As can be seen in FIG. 15A, in the first position of brake mechanism 160, second lobe 178 of second arm 172 actuates first pad or shoe 190 against side 224 of housing 158, thereby impeding movement of housing 158 along and about first axis 154, as well as along second axis 156. Brake mechanism 160 is retained in this first position shown in FIG. 15A under the urging provided by biasing member 188 (not shown in FIG. 15A).

As can be seen, for example, by comparison of FIGS. 15A and 15B, movement of brake mechanism 160 from the first position to the second position causes second lobe 178 of second arm 172 to release first pad or shoe 190 in the direction of arrow 226 from contact against side 224 of housing 158, thereby permitting movement of housing 158 along and about first axis 154, as well as along second axis 156. As can also be seen by comparison of FIGS. 15A and 15B, side 222 of second lobe 178 no longer contacts guide shaft 150 in the second position, thereby permitting movement of housing 158 along and about longitudinal axis 152 of guide shaft 150.

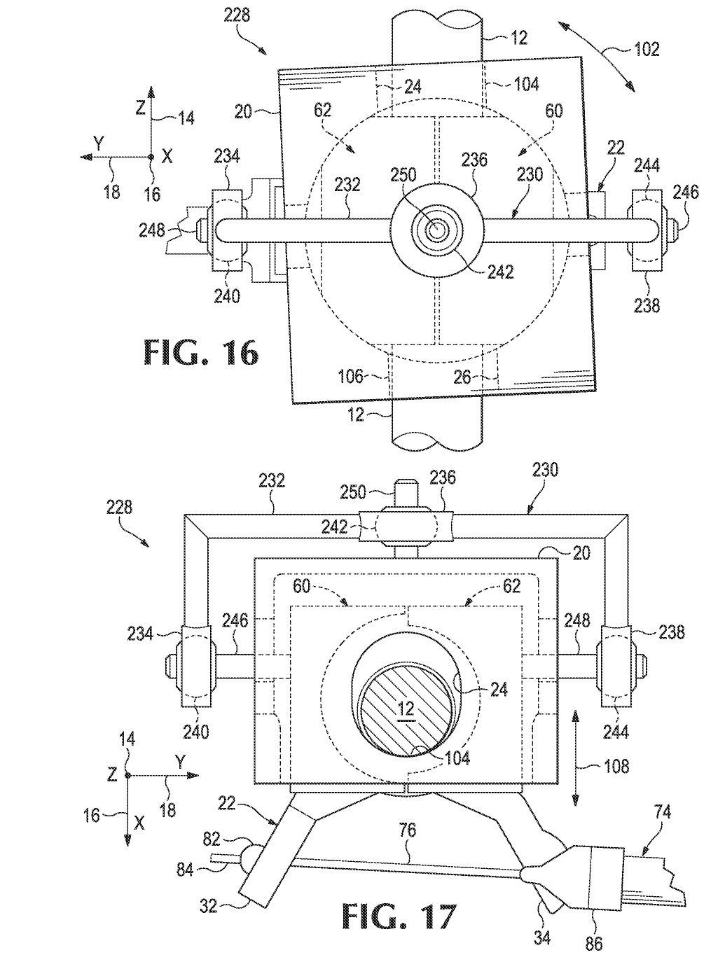

An example of rotation of housing 20 of an alternative positioning assembly 228 about first axis 16 that is transverse to longitudinal axis 14 is shown in FIG. 16. Were applicable, the same reference numerals have been used for positioning assembly 228 as were used for positioning assembly 10. As can be seen in FIG. 16, positioning assembly 228 includes an actuator 230 to move housing 20 of positioning assembly 228 about first axis 16 in either of the directions indicated by double-headed arrow 102. As can also be seen in FIG. 16, the extent of this rotation is limited by contact between side 104 of first opening 24 and guide shaft 12 and side 106 of second opening 26 and guide shaft 12.

Actuator 230 includes an arm 232 having a plurality of attachment points 234, 236, and 238 in which respective joints or bushings 240, 242, and 244 are disposed. As can additionally be seen in FIG. 16, first pad or shoe 60 of brake mechanism 22 of positioning assembly 228 includes a shaft 246 that is received in bushing or joint 244 and second pad or shoe 62 includes a shaft 248 that is received in bushing or joint 240 to help mount actuator 230. As can further be seen in FIG. 16, housing 20 includes a shaft 250 that is received in bushing or joint 242 to also help mount actuator 230.

An example of movement of housing 20 of positioning assembly 228 along first axis 16 is shown in FIG. 17. As can be seen in FIG. 17, brake mechanism 22 is in the first position that permits actuator 230 to move housing 20 along first axis 16 in either of the directions of double-headed arrow 108 which is substantially parallel to first axis 16. As can also be seen in FIG. 17, the extent of this movement is limited by contact between side 104 of first opening 24 and guide shaft 12. Contact between side 106 of second opening 26 (not shown in FIG. 17) and guide shaft 12 also limits the extent of this movement.

Actuator 230 may move housing 20 along first axis 16 in either of the directions indicated by double-headed arrow 108 and about first axis 16 in either of the directions indicated by double-headed arrow 102 through any of a variety of different ways. For example, a motor (not shown) may be mounted to shaft 250. As another example, shaft 250 may be magnetized and an electric coil (not shown) may be disposed in attachment point 236. As a further example, one or more hydraulic cylinders (not shown) may be used by actuator 230 to control movement in either or both of the directions indicated by double-headed arrows 102 and 108.

Although several drawings have been described and illustrated in detail, it is to be understood that the same are intended by way of illustration and example only. These examples are not intended to be exhaustive or to be limited to the precise form disclosed. Modifications and variations may well be apparent to those of ordinary skill in the art.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A positioning assembly, comprising:
a guide shaft having a longitudinal axis, a first axis, and a second axis;
a housing disposed on the guide shaft; and
a brake mechanism disposed on the guide shaft and moveable between a first position that permits movement of the housing along and about the longitudinal axis, along and about the first axis, and along the second axis, and a second position that impedes movement of the housing along and about the longitudinal axis, along and about the first axis, and along the second axis.

2. The positioning assembly of claim 1, wherein the first axis is substantially perpendicular to the longitudinal axis, and further wherein the second axis is substantially perpendicular to the first axis.

3. The positioning assembly of claim 1, wherein the brake mechanism includes:
a first arm having a first lobe;
a second arm having a second lobe;
a first pad actuated by the first lobe; and
a second pad actuated by the second lobe.

4. The positioning assembly of claim 3, wherein the first lobe of the first arm actuates the first pad against the housing in the second position of the brake mechanism, and further wherein the second lobe of the second arm actuates the second pad against the housing in the second position of the brake mechanism.

5. The positioning assembly of claim 3, wherein the first arm is eccentrically mounted on the guide shaft and the second arm is eccentrically mounted on the guide shaft.

6. The positioning assembly of claim 5, wherein the eccentric mounting of the first and second arms on the guide shaft helps impede movement of the housing along and about the longitudinal axis in the second position of the brake mechanism.

7. The positioning assembly of claim 3, wherein the first and second arms are in closer proximity to one another in the second position than in the first position.

8. The positioning assembly of claim 1, further comprising an actuator to move the brake mechanism between the first position and the second position.

9. The positioning assembly of claim 1, further comprising a device coupled to the housing so as to be moveable therewith, wherein the second position of the brake mechanism impedes movement of the device independent of application of resistive forces on the device.

10. The positioning assembly of claim 1, further comprising a biasing assembly to help retain the brake mechanism in the first position.

11. The positioning assembly of claim 1, further comprising an actuator to one of move the housing along the first axis and move the housing about the first axis.

12. The positioning assembly of claim 11, wherein the actuator includes an arm and a plurality of joints.

13. A positioning assembly, comprising:
a guide shaft having a longitudinal axis;
a housing movable along and rotatable about the longitudinal axis of the guide shaft and also transversely movable and transversely rotatable with respect to the longitudinal axis of the guide shaft; and
a brake mechanism including at least one shoe and a caliper eccentrically mounted on the guide shaft and moveable from a first position that permits movement and rotation of the housing to a second position that impedes movement and rotation of the housing.

14. The positioning assembly of claim 13, further comprising an actuator to move the caliper between the first position and the second position.

15. The positioning assembly of claim 13, further comprising a device coupled to the housing so as to be moveable therewith, wherein the second position of the caliper impedes movement of the device independent of application of resistive forces on the device.

16. The positioning assembly of claim 13, wherein the caliper includes a first arm and a second arm, and further wherein the first and second arms are in closer proximity to one another in the first position than in the second position.

17. The positioning assembly of claim 13, further comprising a biasing assembly to help retain the caliper in the first position.

18. The positioning assembly of claim 13, wherein engagement between the guide shaft and the eccentrically mounted caliper of the brake mechanism in the second position impedes movement of the housing along and about the longitudinal axis of the guide shaft.

19. The positioning assembly of claim 13, wherein engagement between the housing and the at least one shoe of the brake mechanism in the second position impedes movement and rotation of the housing transverse to the longitudinal axis of the guide shaft.

20. The positioning assembly of claim 13, further comprising an actuator to one of transversely move the housing with respect to the longitudinal axis of the guide shaft and transversely rotate the housing with respect to the longitudinal axis of the guide shaft.
